(19) United States
(12) Patent Application Publication
(10) Pub. No.: US 2023/0042409 A1
(43) Pub. Date: Feb. 9, 2023

(54) METHODS, SYSTEMS, AND COMPUTER PROGRAM PRODUCTS FOR MANAGING RESOURCE CAPACITY USING QUALITY OF SERVICE (QoS) BANDS BASED ON TRANSACTION REQUEST MODELING AND DESTINATION CAPACITY MODELING

(71) Applicant: Change Healthcare Holdings LLC, Nashville, TN (US)

(72) Inventors: Arien Malec, Oakland, CA (US); André Viljoen, North Vancouver (CA); Cindy Klain, Mansfield, MA (US); Heather Wilson, Westminster, CO (US); Mary Craig, Murfreesboro, TN (US); Thomas Cosley, Guttenberg, IA (US); Karen Phillips, Raleigh, NC (US); Gary Stewart, Trabuco Canyon, CA (US); Chris Compton, Fort Worth, TX (US)

(21) Appl. No.: 17/393,984

(22) Filed: Aug. 4, 2021

(51) Int. Cl. G06Q 40/08; G06F 30/27

(52) U.S. Cl. CPC G06Q 40/08; G06F 30/27

(57) ABSTRACT

A method includes generating a payor channel capacity model by modeling a channel capacity between a resource management system and a payor; generating a transaction request model by modeling transaction requests destined for the payor; defining a plurality of Quality of Service (QoS) bands based on the payor channel capacity model and the transaction request model, respective ones of the plurality of QoS bands being indicative of a measure of relative opportunity to establish a connection on the channel between the resource management system and the payor; receiving a current transaction request for the payor at the resource management system; assigning the current transaction request to one of the QoS bands; and establishing a current connection on the channel between the resource management system and the payor to communicate the current transaction request from the resource management system to the payor based on the QoS band assigned to the current transaction request.

### FIELD

The present inventive concepts relate generally to health care systems and services and, more particularly, to management of transactions between health care service providers and payors.

### BACKGROUND

In caring for a patient, a health care service provider may interact with one or more health care payment plan administrators, e.g., a private insurance entity, government insurance entity, and/or a medical expense sharing organization, which may be referred to as a “payor.” For example, a health care service provider may query a health care payment plan administrator or payor to determine a patient's eligibility under a payment plan or coverage plan offered by the payor. This eligibility query may be performed at various stages during the patient care process, such as, for example, in advance of a patient's appointment, when the patient arrives for the appointment, and/or when generating a bill after a patient has been cared for by a health care service provider. The payment plan or coverage plan eligibility determination is used to ensure that the patient is billed correctly and receives all the benefits that the patient is entitled to. A health care service provider may also generate claims for services and/or products rendered to a patient and submit these claims to one or more payors that are responsible for paying for all or a portion of the patient's expenses.

An intermediary may be used to act as a clearinghouse for partially processing and routing transaction requests and responses between health care service providers and payors. Such an intermediary may be an automatically scalable, microservice based, software-as-a-service offering hosted on third party cloud infrastructure.

When developing and deploying applications on dedicated infrastructure, such as application(s) for processing transactions at a payor's data center, resource constraints may be a key architectural driver. Resource exhaustion may be the exception, and not the rule. Resources (e.g., CPU, memory, network, and storage) are finite, and may be actively managed. Applications may be designed and performance tested to never exceed capacity. When an application consumes all resources available, it may result in unpredictable application behavior and application failure.

This generally does not hold true for cloud-based microservice architectures, such as a cloud-based intermediary for routing transactions between health care service providers and payors. The scale of computing and networking infrastructure available at cloud-based service providers, coupled with a stateless, serverless microservice architecture, may give software-as-a-service applications more resources than available to any external dependencies/services. In practice, it means that a well-architected cloud application may exhaust resources of external services or applications that it consumes before exhausting resources available to it.

When designing software-as-a-service applications, such as a cloud-based intermediary for routing transactions between health care service providers and payors, capacity management to protect external resources (e.g., a payor's data center or IT infrastructure) may be a challenge due to the non-deterministic operating environment coupled with the non-deterministic nature of the network connecting to external services.

### SUMMARY

According to some embodiments of the inventive concept, a method comprises: generating a payor channel capacity model by modeling a channel capacity between a resource management system and a payor; generating a transaction request model by modeling transaction requests destined for the payor; defining a plurality of Quality of Service (QoS) bands based on the payor channel capacity model and the transaction request model, respective ones of the plurality of QoS bands being indicative of a measure of relative opportunity to establish a connection on the channel between the resource management system and the payor; receiving a current transaction request for the payor at the resource management system; assigning the current transaction request to one of the QoS bands; and establishing a current connection on the channel between the resource management system and the payor to communicate the current transaction request from the resource management system to the payor based on the QoS band assigned to the current transaction request.

In other embodiments, a number of the plurality of QoS bands is N. The method further comprises ranking the plurality of QoS bands from a highest priority of N to a lowest priority of 1. The measure of relative opportunity of respective ones of the plurality of QoS bands to establish a connection on the channel between the resource management system and the payor is reduced from 100% by ((N−the priority of the respective one of the plurality of QoS bands)/N)*100.

In still other embodiments, generating the transaction request model comprises: generating the transaction request model based on a transaction request origination mode for at least a portion of the transaction requests destined for the payor.

In still other embodiments, the transaction request origination mode comprises: a batch mode and a real-time mode.

In still other embodiments, the batch mode comprises: a plurality of batch mode categories based on a plurality of expected transaction request response times, respectively.

In still other embodiments, generating the transaction request model comprises: generating the transaction request model based on originating application type for at least a portion of the transaction requests destined for the payor.

In still other embodiments, generating the payor channel capacity model comprises: generating the payor channel capacity model based on payor channel capacity factors. The payor channel capacity factors comprising: a response failure rate for transaction requests previously communicated to the payor; a distribution of times spent buffered at the resource management system for the transaction requests previously communicated to the payor; and a defined rate limit for the payor that specifies a number of transaction requests that can be accepted per unit of time; or using an Artificial Intelligence (AI) system to model the payor channel capacity over a training time period based on transaction requests communicated to the payor during the training time period and response failures generated by the payor during the training time period in response to the transaction requests communicated to the payor during the training time period.

In still other embodiments, assigning the current transaction request to one of the QoS bands comprises: assigning the current transaction request to the one of the QoS bands based on a time that a source of the current transaction request is willing to wait for the current transaction request to be communicated to the payor.

In still other embodiments, assigning the current transaction request to one of the QoS bands comprises: assigning the current transaction request to the one of the QoS bands based on a frequency at which a source of the current transaction request will re-submit the current transaction request in response to a failure to receive a response to the current transaction request from the payor.

In still other embodiments, assigning the current transaction request to one of the QoS bands comprises: assigning the current transaction request to the one of the QoS bands based on a default QoS band assigned to a submitter of the current transaction request.

In still other embodiments, generating the payor channel capacity model; generating the transaction request model; and defining a plurality of QoS bands are performed during a first time interval, the method further comprising: updating the payor channel capacity model by modeling the channel capacity between a resource management system and a payor during a second time interval; updating the transaction request model by modeling transaction requests destined for the payor during the second time interval; and defining the plurality of QoS bands based on the payor channel capacity model and the transaction request model that have been updated.

In still other embodiments, the payor is a private or public insurance entity and the transaction requests comprise a patient insurance coverage eligibility request and/or a claim generated by a health care service provider.

In some embodiments of the inventive concept, a system comprises a processor; and a memory coupled to the processor and comprising computer readable program code embodied in the memory that is executable by the processor to perform operations comprising: generating a payor channel capacity model by modeling a channel capacity between a resource management system and a payor; generating a transaction request model by modeling transaction requests destined for the payor; defining a plurality of Quality of Service (QoS) bands based on the payor channel capacity model and the transaction request model, respective ones of the plurality of QoS bands being indicative of a measure of relative opportunity to establish a connection on the channel between the resource management system and the payor; receiving a current transaction request for the payor at the resource management system; assigning the current transaction request to one of the QoS bands; and establishing a current connection on the channel between the resource management system and the payor to communicate the current transaction request from the resource management system to the payor based on the QoS band assigned to the current transaction request.

In further embodiments, generating the transaction request model comprises: generating the transaction request model based on a transaction request origination mode for at least a portion of the transaction requests destined for the payor.

In still further embodiments, the transaction request origination mode comprises a batch mode and a real-time mode.

In still further embodiments, generating the transaction request model comprises: generating the transaction request model based on originating application type for at least a portion of the transaction requests destined for the payor.

In still further embodiments, generating the payor channel capacity model comprises: generating the payor channel capacity model based on payor channel capacity factors. The payor channel capacity factors comprising: a response failure rate for transaction requests previously communicated to the payor; a distribution of times spent buffered at the resource management system for the transaction requests previously communicated to the payor; and a defined rate limit for the payor that specifies a number of transaction requests that can be accepted per unit of time; or using an Artificial Intelligence (AI) system to model the payor channel capacity over a training time period based on transaction requests communicated to the payor during the training time period and response failures generated by the payor during the training time period in response to the transaction requests communicated to the payor during the training time period.

In still further embodiments, assigning the current transaction request to one of the QoS bands comprises: assigning the current transaction request to the one of the QoS bands based on a time that a source of the current transaction request is willing to wait for the current transaction request to be communicated to the payor.

In still further embodiments, assigning the current transaction request to one of the QoS bands comprises: assigning the current transaction request to the one of the QoS bands based on a frequency at which a source of the current transaction request will re-submit the current transaction request in response to a failure to receive a response to the current transaction request from the payor.

In still further embodiments, generating the payor channel capacity model; generating the transaction request model; and defining a plurality of QoS bands are performed during a first time interval, the operations further comprising: updating the payor channel capacity model by modeling the channel capacity between a resource management system and a payor during a second time interval; updating the transaction request model by modeling transaction requests destined for the payor during the second time interval; and defining the plurality of QoS bands based on the payor channel capacity model and the transaction request model that have been updated.

In some embodiments of the inventive concept, a computer program product, comprises a non-transitory computer readable storage medium comprising computer readable program code embodied in the medium that is executable by a processor to perform operations comprising: generating a payor channel capacity model by modeling a channel capacity between a resource management system and a payor; generating a transaction request model by modeling transaction requests destined for the payor; defining a plurality of Quality of Service (QoS) bands based on the payor channel capacity model and the transaction request model, respective ones of the plurality of QoS bands being indicative of a measure of relative opportunity to establish a connection on the channel between the resource management system and the payor; receiving a current transaction request for the payor at the resource management system; assigning the current transaction request to one of the QoS bands; and establishing a current connection on the channel between the resource management system and the payor to communicate the current transaction request from the resource management system to the payor based on the QoS band assigned to the current transaction request

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive concept will be or become apparent to one with skill in the art upon review of the following drawings and detailed description. It is intended that all such additional systems, methods, articles of manufacture, and/or computer program products be included within this description, be within the scope of the present inventive subject matter and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including a resource management system for managing transaction requests and responses between parties in accordance with some embodiments of the inventive concept;

FIG. 2 is a block diagram that illustrates the resource management system of FIG. 1 in accordance with some embodiments of the inventive concept;

FIGS. 3-6 are flowcharts that illustrate operations for managing transaction requests and responses between parties in accordance with some embodiments of the inventive concept;

FIG. 9 is a data processing system that may be used to implement a resource management system for managing transaction requests and responses between parties in accordance with some embodiments of the inventive concept; and

FIG. 10 is a block diagram that illustrates a software/hardware architecture for use in in a resource management system for managing transaction requests and responses between parties in accordance with some embodiments of the inventive concept.

### DETAILED DESCRIPTION

In the following detailed description, numerous specific details are set forth to provide a thorough understanding of embodiments of the inventive concept. However, it will be understood by those skilled in the art that embodiments of the inventive concept may be practiced without these specific details. In some instances, well-known methods, procedures, components and circuits have not been described in detail so as not to obscure the inventive concept. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, the term “provider” may mean any person or entity involved in providing health care products and/or services to a patient.

Embodiments of the inventive concept are described herein in the context of managing transaction requests and responses between providers and payors, e.g., health care payment plan administrators, such as private insurance entities, government insurance entities, and/or medical expense sharing entities. It will be understood that embodiments of the inventive concept are not limited to managing transaction requests and responses between providers and payors, but may include any type of transaction request source or submitter and any type of recipient or sink for the transaction request.

Embodiments of the inventive concept are described herein in the context of a resource management system for managing transaction requests and responses between parties that includes an artificial intelligence (AI) engine, which uses machine learning. It will be understood that embodiments of the inventive concept are not limited to a machine learning implementation of the resource management system and other types of AI systems may be used including, but not limited to, a multi-layer neural network, a deep learning system, a natural language processing system, and/or computer vision system. Moreover, it will be understood that the multi-layer neural network is a multi-layer artificial neural network comprising artificial neurons or nodes and does not include a biological neural network comprising real biological neurons.

As used herein, “real time” means without the insertion of any artificial delays in time.

Some embodiments of the inventive concept stem from a realization that the use of an intermediary located in the cloud, such as a clearinghouse for processing transaction requests and responses between providers and payors, may overwhelm the capacity of a payor's data processing system infrastructure. This may be due to the potentially large number of providers that may submit transaction requests to a single payor and/or the resource scalability capability of the intermediary resulting from access to cloud computing, networking, and storage resources. Embodiments of the inventive concept may provide a resource management system that is part of a clearinghouse or intermediary for processing and routing transaction requests and responses between providers and payors. To reduce the likelihood of receiving a timeout or failure response from a payor, the resource management system may model the channel capacity between the resource management system and a payor and also model the transaction requests destined for the payor from one or more providers. Based on the payor channel capacity model and the transaction request model, multiple Quality of Service (QoS) bands may be defined that are each indicative of a measure of relative opportunity to establish a connection on the channel between the resource management system and a payor. When a current transaction request for the payor is received at the resource management system, the current transaction request may be assigned to one of the QoS bands based on a priority or urgency associated with the current transaction request. For example, the current transaction request may be assigned to one of the QoS bands based on a time that the source of the current transaction request is willing to wait for the current transaction request to be communicated to the payor. The current transaction request may also be assigned to one of the QoS bands based on a frequency at which a source of the current transaction request will re-submit the current transaction request in response to a failure to receive a response from the payor. In some embodiments, providers or sources of transaction requests may each be assigned to one of the QoS bands. For example, each provider or source of transaction requests may be assigned to the highest priority QoS band as a default. But some providers or sources of transaction requests may be assigned to a lower priority QoS band as a default based on their transaction request frequency characteristics. A provider or source that transmits batch transaction requests with an expected response time of 12 hours or longer may be assigned to a lower QoS band than a provider or source that transmits transaction requests in real time with an expectation for a response within seconds or minutes. The resource management system may, therefore, allocate the incoming transaction requests from providers to a payor to different QoS bands for communication to the payor to avoid exceeding the capacity of the payor's data processing system and network resource infrastructure (e.g., avoid exceeding the maximum number of allowable connections at one time or during a given time period), which may reduce the likelihood of a timeout or receiving a failure response from the payor.

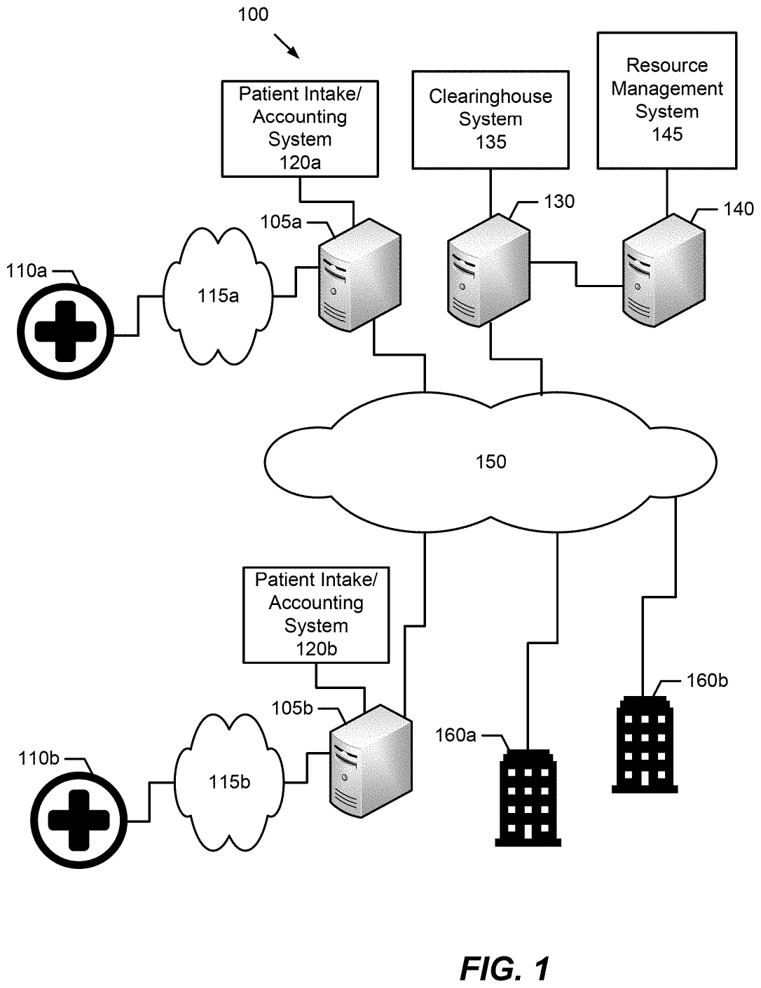

Referring to FIG. 1, a communication network 100 including a resource management system for managing transaction requests and responses between parties, in accordance with some embodiments of the inventive concept, comprises multiple health care provider facilities or practices 110a, 110b. Each health care provider facility or practice may represent various types of organizations that are used to deliver health care services to patients via health care professionals, which are referred to generally herein as “providers.” The providers may include, but are not limited to, hospitals, medical practices, mobile patient care facilities, diagnostic centers, lab centers, pharmacies, and the like. The providers may operate by providing health care services for patients and then invoicing one or more payors 160a and 160b for the services rendered. The payors 160a and 160b may include, but are not limited to, providers of private insurance plans, providers of government insurance plans (e.g., Medicare, Medicaid, state, or federal public employee insurance plans), providers of hybrid insurance plans (e.g., Affordable Care Act plans), private of private medical cost sharing plans, and the patients themselves. Two provider facilities 110a, 110b are illustrated in FIG. 1 with the first provider including a first patient intake/accounting system server 105a accessible via a network 115a. The first patient intake/accounting system server 105a may be configured with a patient intake/accounting system module 120a to manage the intake of patients for appointments and to generate invoices for payors for services and products rendered through the provider 110a. The patient intake/accounting system 120a may be configured to perform payment plan eligibility confirmation to ensure that a patient is covered by a particular payment plan. The patient intake/accounting system 120a may generate a patient eligibility confirmation request for a payor at various times when serving a patient. For example, an eligibility confirmation request may be generated prior to a patient's appointment. Some health care service providers, for example, generate eligibility confirmation requests for all patients that will be seen in a particular week or other time period. An eligibility confirmation request may also be generated when a patient arrives for an appointment. An eligibility confirmation request may also be generated when a health care service provider generates an invoice for services and products rendered in caring for a patient. The network 115a communicatively couples the first patient intake/accounting system server 105a to other devices, terminals, and systems in the provider's facility 110a. The network 115a may comprise one or more local or wireless networks to communicate with first patient intake/accounting system server 105a when the first patient intake/accounting system server 105a is located in or proximate to the health care service provider facility 110a. When the first patient intake/accounting system server 105a is in a remote location from the health care facility, such as part of a cloud computing system or at a central computing center, then the network 115a may include one or more wide area or global networks, such as the Internet. The second provider facility 110b is similar to the first provider facility 110a and includes a second patient intake/accounting system server 105b, which is configured with a patient intake/accounting system server 120b. The second patient intake/accounting system server 105b is coupled to other devices, terminals, and systems in the provider's facility 110b via a network 115b.

According to embodiments of the inventive concept, a system may use an intermediary between health care service providers and payors for managing transaction requests and responses between the providers and payors. An intermediary server 130 may include a clearinghouse system module 135 that may be configured to receive incoming transaction requests from one or more providers 110a, 110b, route these transaction requests to the appropriate payor 160a, 160b, and route the payor responses back to the appropriate provider 110a, 110b by way of the patient intake/accounting systems 120a, 120b. The transaction requests may include, but are not limited to, patient eligibility confirmation requests for payment coverage plans (e.g., insurance benefit plans, expense sharing plans, and the like) and claims for reimbursement for medical expense cover plans (e.g., insurance benefit plans, expense sharing plans, flexible spending account plans, and the like). The intermediary may further include a resource server 140 that includes a resource management system module 145. The resource management system module 145 may be configured to model the channel capacity to the payor 160a, 160b and also model the transaction requests destined for the payor 160a, 160b from one or more providers 110a 110b. The resource management system 145 may be used to define multiple QoS bands that are each indicative of a measure of relative opportunity to establish a connection on the channel to a payor. When a current transaction request for the payor is received the current transaction request may be assigned to one of the QoS bands based on a priority or urgency associated with the current transaction request and/or based on a default QoS band associated with the provider 110a, 110 or submitter. The intermediary server 130, the clearinghouse system module 135, the resource server 140, and the resource system management module 145 may be viewed collectively as a resource management system for managing transaction requests and responses between parties, such as between providers 110a, 110b and payors 160a, 160b in accordance with some embodiments of the inventive concept.

A network 150 couples the patient intake/accounting system servers 105a, 105b to the intermediary server 130 and couples the payors 160a and 160b to the eligibility/coverage interface system server 130. The network 150 may be a global network, such as the Internet or other publicly accessible network. Various elements of the network 150 may be interconnected by a wide area network, a local area network, an Intranet, and/or other private network, which may not be accessible by the general public. Thus, the communication network 150 may represent a combination of public and private networks or a virtual private network (VPN). The network 150 may be a wireless network, a wireline network, or may be a combination of both wireless and wireline networks.

The service provided through the intermediary server 130, the clearinghouse system module 135, the resource server 140, and the resource system management module 145 for managing transaction requests and responses between parties may, in some embodiments, be embodied as a cloud service. For example, health care service providers and/or payors may access the resource management system as a Web service. In some embodiments, the resource management system service may be implemented as a Representational State Transfer Web Service (RESTful Web service).

Although FIG. 1 illustrates an example communication network including a resource management system service for managing transaction requests and responses between parties, it will be understood that embodiments of the inventive subject matter are not limited to such configurations, but are intended to encompass any configuration capable of carrying out the operations described herein.

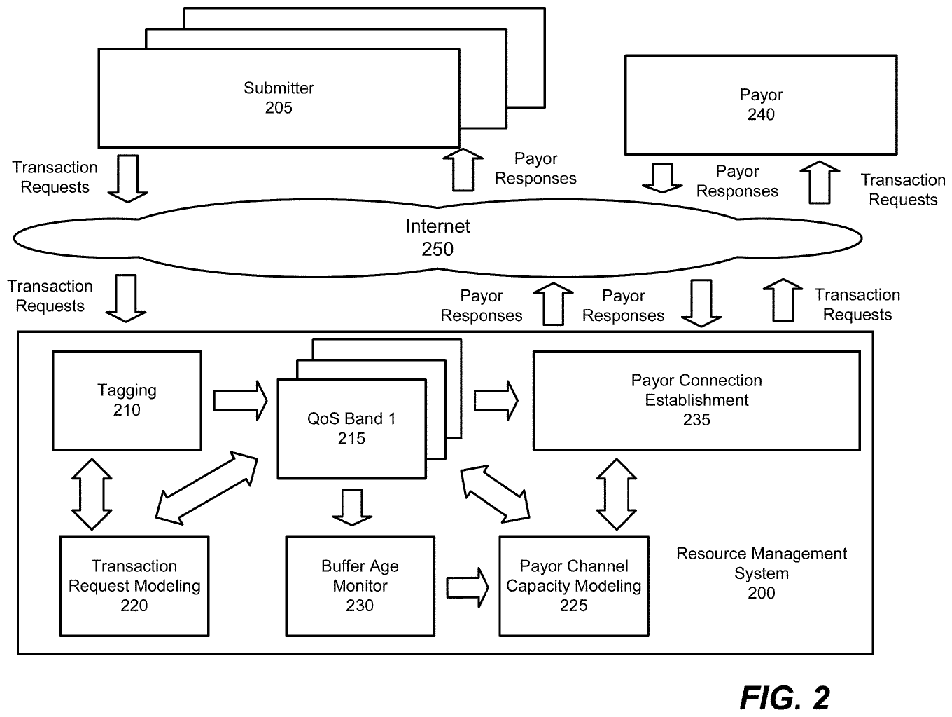

FIG. 2 is a block diagram that illustrates the resource management system of FIG. 1 in accordance with some embodiments of the inventive concept. The resource management system 200 of FIG. 2 may be representative of the intermediary server 130, the clearinghouse system module 135, the resource server 140, and the resource system management module 145 of FIG. 1. Referring to FIG. 2, one or more submitters 205, such as the providers 110a, 110b of FIG. 1, may generate transaction requests for one or more payors. In the example of FIG. 2, one payor 240 is shown for purposes of illustration. The resource management system 200 may be implemented as a cloud service to process and route transaction requests generated by the submitters 205 and the responses thereto generated by the payor 240. Thus, the submitters 205, payor 240, and resource management system 200 may be coupled via the Internet 250, which may be the same communication network 150 described above with respect to FIG. 1.

Transaction requests may be generated by the submitters 205 and received at the resource management system 200 where they are tagged based on priority by a tagging module 210. Based on their priority or urgency, each transaction request is assigned to one of the QoS bands 215. In some embodiments, a submitter 205 may be assigned to one of the QoS bands. For example, as a default, each submitter 205 of transaction requests may be assigned to a highest priority QoS band as a default. In some embodiments, however, a submitter 205 may be assigned to a lower priority QoS band as a default based on their transaction request frequency characteristics. A submitter 205 that typically transmits batch transaction requests with a relatively length expected response time may be assigned to a lower priority QoS band than a submitter 205 that submits transaction requests in real time with an expected response time measured in minutes or seconds. The QoS bands are indicative of a measure of relative opportunity to establish a connection on the channel between the resource management system 200 and the payor 240. For example, if ten QoS bands are defined, then the highest priority QoS band may have access to 100% of the opportunities (e.g., time slots) to access the channel between the resource management system 200 and the payor 240; the second highest priority QoS band may have access to 90% of the opportunities (e.g., time slots) to access the channel between the resource management system 200 and the payor 240; the third highest priority QoS band may have access to 80% of the opportunities (e.g., time slots) to access the channel between the resource management system 200 and the payor 240; the fourth highest priority QoS band may have access to 70% of the opportunities (e.g., time slots) to access the channel between the resource management system 200 and the payor 240; the fifth highest priority QoS band may have access to 60% of the opportunities (e.g., time slots) to access the channel between the resource management system 200 and the payor 240; the sixth highest priority QoS band may have access to 50% of the opportunities (e.g., time slots) to access the channel between the resource management system 200 and the payor 240; the seventh highest priority QoS band may have access to 40% of the opportunities (e.g., time slots) to access the channel between the resource management system 200 and the payor 240; the eighth highest priority QoS band may have access to 30% of the opportunities (e.g., time slots) to access the channel between the resource management system 200 and the payor 240; the ninth highest priority QoS band may have access to 20% of the opportunities (e.g., time slots) to access the channel between the resource management system 200 and the payor 240; and the tenth highest priority QoS band may have access to 10% of the opportunities (e.g., time slots) to access the channel between the resource management system 200 and the payor 240. Thus, some embodiments of the inventive concept may allow for ranking the plurality of QoS bands from a highest priority of N to a lowest priority of 1. The measure of relative opportunity of respective ones of the plurality of QoS bands to establish a connection on the channel between the resource management system 200 and the payor 240 may be reduced from 100% by ((N−the priority of the respective one of the plurality of QoS bands)/N)*100.

The QoS bands may be defined based on a transaction request model generated by the transaction request modeling module 220 and a payor channel capacity model generated by the payor channel capacity modeling module 225. The transaction request modeling module 220 may be configured to analyze incoming transaction requests to generate the transaction request model based on various factors including, but not limited to, the origination mode for the transaction request. For example, transaction requests may be originated in a batch mode or a real-time mode. Moreover, batch mode may have multiple batch mode categories based on different expected transaction request response times. The transaction request model may be further generated based on the origination application type. For example, some application types typically submit requests that necessitate a more rapid response, while other application types can tolerate longer delays before a response is returned. The payor channel capacity modeling module 225 may be configured to analyze the capacity of the channel between the resource management system 200 and the payor 240 using a variety of factors including, but not limited to, a response failure rate from the payor, a distribution of times spent buffered in the QoS bands for transaction requests, which may be provided by the buffer age monitor module 230, a defined rate limit that is provided or advertised by the payor, and/or an analysis provided by an Artificial Intelligence (AI) engine based on transaction requests communicated to the payor 240 during a training time period and response failures generated by the payor 240 during the training period as part of generating the AI model for the channel capacity.

The payor connection establishment module 235 may retrieve transaction requests from the QoS bands 215 and establish connections with the payor 240 to communicate the transaction requests to the payor 240. The resource management system 200 may route responses to the transaction requests to the submitters 205.

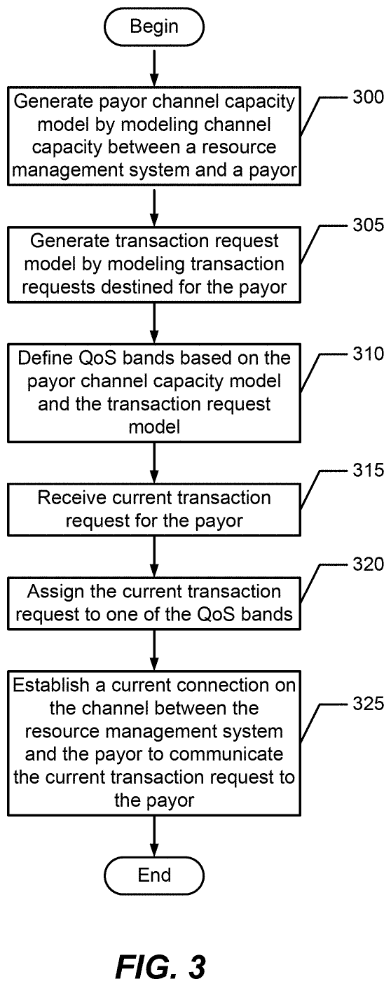

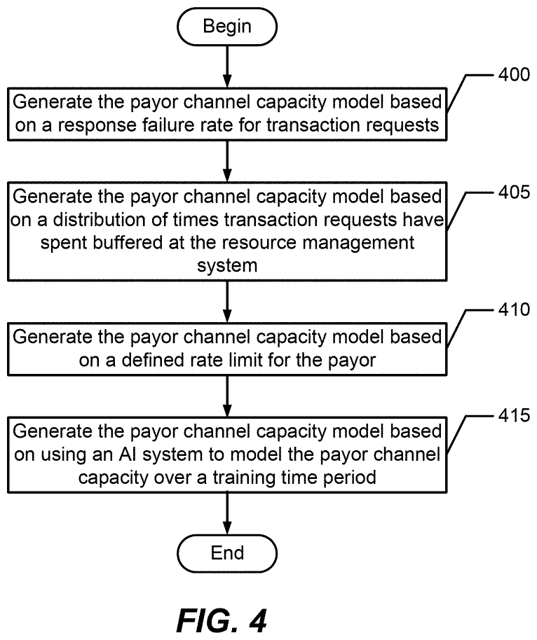

FIGS. 3-6 are flowcharts that illustrate operations managing transaction requests and responses between parties in accordance with some embodiments of the inventive concept. Referring to FIG. 3, operations begin where a payor channel capacity model is generated by modeling the capacity between a resource management system 200 and a payor 240 (block 300). The channel capacity model may be generated based on a variety of factors. Referring now to FIG. 4, the payor channel capacity model may be generated based on a response failure rate for transaction requests (block 400), a distribution of times that transaction requests have been spent buffered at the resource management system 240 in the QoS bands 215 (block 405), a defined rate limit for the payor, e.g., a maximum number of connections per unit of time (block 410), or by using an AI engine or system to model the payor channel capacity over a training time period (block 415).

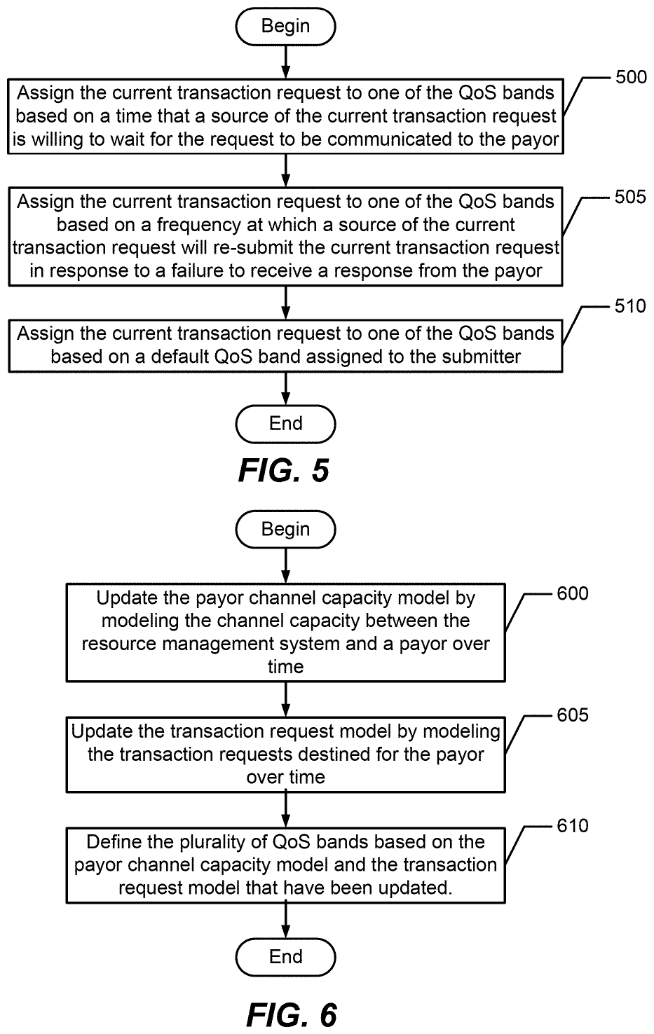

Returning to FIG. 3, a transaction request model is generated by modeling transaction requests destined for the payor 240 (block 305). As described above, the transaction request model may be generated based on factors, such as the origination mode for the transaction request, which may include batch mode and a real-time mode. The batch mode may have multiple batch mode categories based on different expected transaction request response times. The transaction request model may be further generated based on the origination application type, as some applications may require a more rapid response while other application types may tolerate a longer delay before a payor response is returned. The QoS bands 215 are defined based on the payor channel capacity model and the transaction request model (block 310). When the resource management system 200 receives a current transaction request for a payor (block 315), the current transaction request is assigned to one of the QoS bands (block 320). Various factors may be used in determining the QoS band 215 to which the current transaction request is to be assigned. These factors may include one or more of the factors described above with respect to block 305 in modeling the transaction requests destined for the payor. Other factors may include those set forth in FIG. 5, such as assigning the current transaction request to one of the QoS bands based on a time that the source (e.g., submitter, health care service provider, specific application, etc.) of the current transaction is willing to wait for the request to be communicated to the payor 240 (block 500), a frequency at which the source of the current transaction request will re-submit the current transaction request in response to a failure to receive a response from the payor 240 (block 505), and a default QoS band assigned to the submitter 205 (block 510).

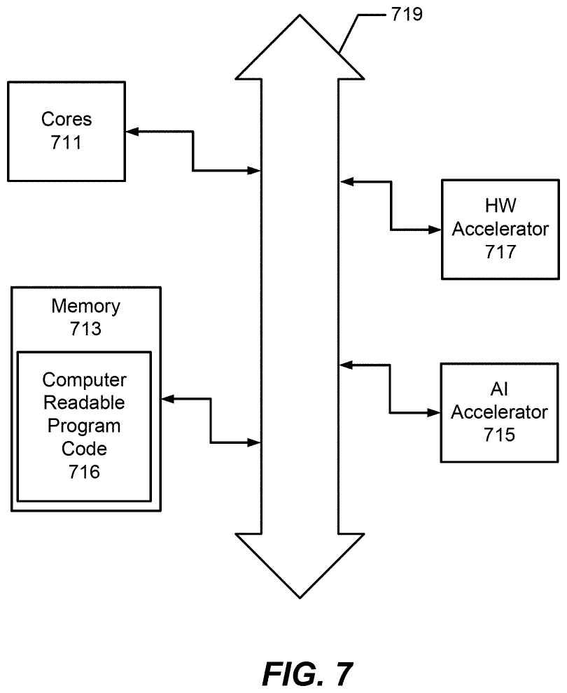

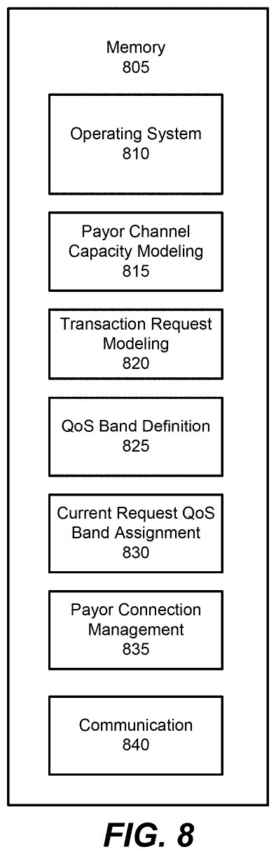

Returning to FIG. 3, a current connection is established on the channel between the resource management system 200 and the payor 240 and the payor connection establishment module 235 communicates the current transaction request to the payor 240. The payor connection establishment module 235 may continue to transmit transaction requests assigned to the QoS bands 215 and destined for the payor 240 until the payor channel capacity model indicates that the channel capacity has been reached. In accordance with some embodiments of the inventive concept, the resource management system 200 may dynamically manage the transaction requests between providers and payors to improve the utilization of the payor's channel capacity over time. This may reduce the likelihood of receiving a timeout or failure response from a payor. In this regard, referring to FIG. 6, the payor channel capacity model may be updated by modeling the channel capacity between the resource management system 200 and the payor 240 over a time period including tracking successful completions of transactions communicated to the payor and failures when a transaction fails to compete within an allotted time (block 600). The transaction request model may be updated by modeling the transaction requests destined for the payor over a time period (block 605). The QoS bands may then be defined based on the updated payor channel capacity model and the updated transaction request model (block 610), which may reflect changing conditions with respect to the payor's channel capacity and/or the characteristics of the transaction requests destined for the payor.

FIG. 7 is a block diagram of a data processing system that may be used to implement the resource server 140 of FIG. 1 and/or the resource management system 200 of FIG. 2 in accordance with some embodiments of the inventive concept. As shown in FIG. 7, the data processing system may include at least one core 711, a memory 713, an artificial intelligence (AI) accelerator 715, and a hardware (HW) accelerator 717. The at least one core 711, the memory 713, the AI accelerator 715, and the HW accelerator 717 may communicate with each other through a bus 719.

The at least one core 711 may be configured to execute computer program instructions. For example, the at least one core 711 may execute an operating system and/or applications represented by the computer readable program code 716 stored in the memory 713. In some embodiments, the at least one core 711 may be configured to instruct the AI accelerator 715 and/or the HW accelerator 717 to perform operations by executing the instructions and obtain results of the operations from the AI accelerator 715 and/or the HW accelerator 717. In some embodiments, the at least one core 711 may be an ASIP customized for specific purposes and support a dedicated instruction set.

The memory 713 may have an arbitrary structure configured to store data. For example, the memory 713 may include a volatile memory device, such as dynamic random-access memory (DRAM) and static RAM (SRAM), or include a non-volatile memory device, such as flash memory and resistive RAM (RRAM). The at least one core 711, the AI accelerator 715, and the HW accelerator 717 may store data in the memory 713 or read data from the memory 713 through the bus 719.

The AI accelerator 715 may refer to hardware designed for AI applications. In some embodiments, the AI accelerator 715 may include a machine learning engine configured to traffic including transaction requests and responses between the resource management system 200 and a payor 240 to model the capacity of the channel therebetween. The AI accelerator 715 may generate output data by processing input data provided from the at least one core 715 and/or the HW accelerator 717 and provide the output data to the at least one core 711 and/or the HW accelerator 717. In some embodiments, the AI accelerator 715 may be programmable and be programmed by the at least one core 711 and/or the HW accelerator 717. The HW accelerator 717 may include hardware designed to perform specific operations at high speed. The HW accelerator 717 may be programmable and be programmed by the at least one core 711.

FIG. 8 illustrates a memory 805 that may be used in embodiments of data processing systems, such as the resource server 140 of FIG. 1, the resource management system 200 of FIG. 2, and the data processing system of FIG. 7, respectively, to facilitate managing transaction requests and responses thereto between parties according to some embodiments of the inventive concept. The memory 805 is representative of the one or more memory devices containing the software and data used for facilitating operations of the resource server 140 and the resource management system module 145 as described herein. The memory 805 may include, but is not limited to, the following types of devices: cache, ROM, PROM, EPROM, EEPROM, flash, SRAM, and DRAM. As shown in FIG. 8, the memory 805 may contain seven or more categories of software and/or data: an operating system 810, a payor channel capacity modeling module 815, a transaction request modeling module 820, a QoS band definition module 825, a current request QoS band assignment module 830, a payor connection management module 835, and a communication module 840. In particular, the operating system 810 may manage the data processing system's software and/or hardware resources and may coordinate execution of programs by the processor.

The payor channel capacity modeling module 815 may be configured to perform one or more of the operations described above with respect to the payor channel capacity modeling module 225 of FIG. 2 and FIGS. 3-6. The transaction request modeling module 820 may be configured to perform one or more of the operations described above with respect to the transaction request modeling module 220 of FIG. 2 and FIGS. 3-6. The QoS band definition module 825 may be configured to perform one or more of the operations described above with respect to the QoS bands 215 of FIG. 2 and FIGS. 3-6. The current request QoS band assignment module 830 may be configured to perform one or more of the operations described above with respect to the tagging module 210 and QoS bands 215 of FIG. 2 and FIGS. 3-6. The payor connection management module 835 may be configured to perform one or more operations described above with respect to the payor connection establishment module 235 of FIG. 2 and FIGS. 3-6. The communication module 830 may be configured to facilitate communication between the resource server 140/resource management system 200 and the payors 160a, 160b/payor 240.

Although FIGS. 7 and 8 illustrate hardware/software architectures that may be used in data processing systems, such as the resource server 140 of FIG. 1, the resource management system 200 of FIG. 2, and the data processing system of FIG. 7, respectively, in accordance with some embodiments of the inventive concept, it will be understood that the present invention is not limited to such a configuration but is intended to encompass any configuration capable of carrying out operations described herein.

Computer program code for carrying out operations of data processing systems discussed above with respect to FIGS. 1-8 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the intermediary server 130 of FIG. 1, the resource server 140 of FIG. 1, the resource management system 240 of FIG. 2, and the data processing system of FIG. 7 may each be implemented as a single processor system, a multi-processor system, a multi-core processor system, or even a network of stand-alone computer systems, in accordance with various embodiments of the inventive concept. Each of these processor/computer systems may be referred to as a “processor” or “data processing system.” The functionality provided by the intermediary server 130 and the resource server 140 may be merged into a single server or maintained as separate servers in accordance with different embodiments of the inventive concept.

The data processing apparatus described herein with respect to FIGS. 1-7 may be used to facilitate managing transaction requests and responses thereto between parties according to some embodiments of the inventive concept described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 805 when coupled to a processor includes computer readable program code that, when executed by the processor, causes the processor to perform operations including one or more of the operations described herein with respect to FIGS. 1-6.

Some embodiments of the inventive concept may provide a resource management system for processing and routing transaction requests and responses between entities, such as providers and payors, in a manner that seeks to not just avoid exceeding or overflowing the connection capacity of a payor, but seeks to improve the percentages of transaction requests that are responded to successfully. The resource management system, according to some embodiments of the inventive concept, may use multiple QoS bands that are each indicative of a measure of relative opportunity to establish a connection on the channel between the resource management system and a payor. These QoS bands are generated, and transaction requests are assigned thereto in a manner that is designed to improve utilization of the available channel capacity to the payor.

### Further Definitions and Embodiments

In the above-description of various embodiments of the present inventive concept, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present inventive concept. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

In the above-description of various embodiments of the present inventive concept, aspects of the present inventive concept may be illustrated and described herein in any of a number of patentable classes or contexts including any new and useful process, machine, manufacture, or composition of matter, or any new and useful improvement thereof. Accordingly, aspects of the present inventive concept may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present inventive concept may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

The description of the present inventive concept has been presented for purposes of illustration and description, but is not intended to be exhaustive or limited to the inventive concept in the form disclosed. Many modifications and variations will be apparent to those of ordinary skill in the art without departing from the scope and spirit of the inventive concept. The aspects of the inventive concept herein were chosen and described to best explain the principles of the inventive concept and the practical application, and to enable others of ordinary skill in the art to understand the inventive concept with various modifications as are suited to the particular use contemplated.

What is claimed is:

1. A method, comprising:
generating a payor channel capacity model by modeling a channel capacity between a resource management system and a payor;
generating a transaction request model by modeling transaction requests destined for the payor;
defining a plurality of Quality of Service (QoS) bands based on the payor channel capacity model and the transaction request model, respective ones of the plurality of QoS bands being indicative of a measure of relative opportunity to establish a connection on the channel between the resource management system and the payor;
receiving a current transaction request for the payor at the resource management system;
assigning the current transaction request to one of the QoS bands; and
establishing a current connection on the channel between the resource management system and the payor to communicate the current transaction request from the resource management system to the payor based on the QoS band assigned to the current transaction request.

2. The method of claim 1, wherein a number of the plurality of QoS bands is N, the method further comprising:
ranking the plurality of QoS bands from a highest priority of N to a lowest priority of 1;
wherein the measure of relative opportunity of respective ones of the plurality of QoS bands to establish a connection on the channel between the resource management system and the payor is reduced from 100% by ((N−the priority of the respective one of the plurality of QoS bands)/N)*100.

3. The method of claim 1, wherein generating the transaction request model comprises:
generating the transaction request model based on a transaction request origination mode for at least a portion of the transaction requests destined for the payor.

4. The method of claim 3, wherein the transaction request origination mode comprises a batch mode and a real-time mode.

5. The method of claim 4, wherein the batch mode comprises a plurality of batch mode categories based on a plurality of expected transaction request response times, respectively.

6. The method of claim 1, wherein generating the transaction request model comprises:
generating the transaction request model based on originating application type for at least a portion of the transaction requests destined for the payor.

7. The method of claim 1, wherein generating the payor channel capacity model comprises:
generating the payor channel capacity model based on payor channel capacity factors comprising:
a response failure rate for transaction requests previously communicated to the payor;
a distribution of times spent buffered at the resource management system for the transaction requests previously communicated to the payor; and
a defined rate limit for the payor that specifies a number of transaction requests that can be accepted per unit of time; or
using an Artificial Intelligence (AI) system to model the payor channel capacity over a training time period based on transaction requests communicated to the payor during the training time period and response failures generated by the payor during the training time period in response to the transaction requests communicated to the payor during the training time period.

8. The method of claim 1, wherein assigning the current transaction request to one of the QoS bands comprises:
assigning the current transaction request to the one of the QoS bands based on a time that a source of the current transaction request is willing to wait for the current transaction request to be communicated to the payor.

9. The method of claim 1, wherein assigning the current transaction request to one of the QoS bands comprises:
assigning the current transaction request to the one of the QoS bands based on a frequency at which a source of the current transaction request will re-submit the current transaction request in response to a failure to receive a response to the current transaction request from the payor.

10. The method of claim 1, wherein assigning the current transaction request to one of the QoS bands comprises:
assigning the current transaction request to the one of the QoS bands based on a default QoS band assigned to a submitter of the current transaction request.

11. The method of claim 1, wherein generating the payor channel capacity model; generating the transaction request model; and defining a plurality of QoS bands are performed during a first time interval, the method further comprising:
updating the payor channel capacity model by modeling the channel capacity between a resource management system and a payor during a second time interval;
updating the transaction request model by modeling transaction requests destined for the payor during the second time interval; and
defining the plurality of QoS bands based on the payor channel capacity model and the transaction request model that have been updated.

12. The method of claim 1, wherein the payor is a private or public insurance entity and the transaction requests comprise a patient insurance coverage eligibility request and/or a claim generated by a health care service provider.

13. A system, comprising:
a processor; and
a memory coupled to the processor and comprising computer readable program code embodied in the memory that is executable by the processor to perform operations comprising:
generating a payor channel capacity model by modeling a channel capacity between a resource management system and a payor;
generating a transaction request model by modeling transaction requests destined for the payor;
defining a plurality of Quality of Service (QoS) bands based on the payor channel capacity model and the transaction request model, respective ones of the plurality of QoS bands being indicative of a measure of relative opportunity to establish a connection on the channel between the resource management system and the payor;
receiving a current transaction request for the payor at the resource management system;
assigning the current transaction request to one of the QoS bands; and
establishing a current connection on the channel between the resource management system and the payor to communicate the current transaction request from the resource management system to the payor based on the QoS band assigned to the current transaction request.

14. The system of claim 13, wherein generating the transaction request model comprises:
generating the transaction request model based on a transaction request origination mode for at least a portion of the transaction requests destined for the payor.

15. The system of claim 14, wherein the transaction request origination mode comprises a batch mode and a real-time mode.

16. The system of claim 13, wherein generating the transaction request model comprises:
generating the transaction request model based on originating application type for at least a portion of the transaction requests destined for the payor.

17. The system of claim 13, wherein generating the payor channel capacity model comprises:
generating the payor channel capacity model based on payor channel capacity factors comprising:
a response failure rate for transaction requests previously communicated to the payor;
a distribution of times spent buffered at the resource management system for the transaction requests previously communicated to the payor; and
a defined rate limit for the payor that specifies a number of transaction requests that can be accepted per unit of time; or
using an Artificial Intelligence (AI) system to model the payor channel capacity over a training time period based on transaction requests communicated to the payor during the training time period and response failures generated by the payor during the training time period in response to the transaction requests communicated to the payor during the training time period.

18. The system of claim 13, wherein assigning the current transaction request to one of the QoS bands comprises:
assigning the current transaction request to the one of the QoS bands based on a time that a source of the current transaction request is willing to wait for the current transaction request to be communicated to the payor.

19. The system of claim 13, wherein assigning the current transaction request to one of the QoS bands comprises:
assigning the current transaction request to the one of the QoS bands based on a frequency at which a source of the current transaction request will re-submit the current transaction request in response to a failure to receive a response to the current transaction request from the payor.

20. The system of claim 13, wherein generating the payor channel capacity model; generating the transaction request model; and defining a plurality of QoS bands are performed during a first time interval, the operations further comprising:
updating the payor channel capacity model by modeling the channel capacity between a resource management system and a payor during a second time interval;
updating the transaction request model by modeling transaction requests destined for the payor during the second time interval; and
defining the plurality of QoS bands based on the payor channel capacity model and the transaction request model that have been updated.

21. A computer program product, comprising:
a non-transitory computer readable storage medium comprising computer readable program code embodied in the medium that is executable by a processor to perform operations comprising:
generating a payor channel capacity model by modeling a channel capacity between a resource management system and a payor;
generating a transaction request model by modeling transaction requests destined for the payor;
defining a plurality of Quality of Service (QoS) bands based on the payor channel capacity model and the transaction request model, respective ones of the plurality of QoS bands being indicative of a measure of relative opportunity to establish a connection on the channel between the resource management system and the payor;
receiving a current transaction request for the payor at the resource management system;
assigning the current transaction request to one of the QoS bands; and
establishing a current connection on the channel between the resource management system and the payor to communicate the current transaction request from the resource management system to the payor based on the QoS band assigned to the current transaction request.
